(19) United States
(12) Patent Application Publication
(10) Pub. No.: US 2026/0212475 A1
(43) Pub. Date: Jul. 23, 2026

(54) DEGREE OF RELIABILITY CALCULATING APPARATUS, IMAGE PROCESSING APPARATUS, IMAGE CAPTURING APPARATUS, DEGREE OF RELIABILITY CALCULATING METHOD, AND STORAGE MEDIUM

(71) Applicant: CANON KABUSHIKI KAISHA, Tokyo (JP)

(72) Inventor: AZUSA SUZUKI, Kanagawa (JP)

(21) Appl. No.: 19/442,140

(22) Filed: Jan. 7, 2026

(30) Foreign Application Priority Data
Jan. 21, 2025 (JP) 2025-008170

(51) Int. Cl. G06T 7/00; G06T 7/73

(52) U.S. Cl. CPC G06T 7/0002; G06T 7/74; G06T 2207/10012; G06T 2207/30168

(57) ABSTRACT

A degree of reliability calculating apparatus configured to calculate a degree of reliability for a parallax between a first image and a second image includes: at least one memory storing instructions; and at least one processor executing the stored instructions causing the degree of reliability calculating apparatus to: set a specific area of the first image as a standard image, and set at least two specific areas of the second image as reference images; acquire a parallax calculated from correlation values indicating an extent of correlation between the standard image and the reference images; estimate a parallax range from positions of the reference images; and calculate a degree of reliability for the parallax acquired based on the estimated parallax range. A high degree of reliability is calculated in a case in which the parallax is included within the parallax range.

### BACKGROUND

### Field of the Technology

The present disclosure relates to a degree of reliability calculating apparatus, an image processing apparatus, an image capturing apparatus, a degree of reliability calculating method, and a storage medium.

### Description of the Related Art

Methods have been proposed in which a plurality of images are acquired, and 3-dimensional information is calculated. For example, generally, a block matching method is used in order to obtain 3-dimensional information from a plurality of images. In this method, in relation to an image 1, and an image 2 that have been captured from different viewpoints, an arbitrary area 1 is set as a standard image in the image 1, and an area 2 is set as a reference image in the image 2, and a search is performed for the area 2 that will be the most similar to the area 1 by changing the pixel positions that set the area 2. During the search, a correlation value that shows a degree of difference (optionally a degree of similarity) between the area 1 and the area 2 is used, and the determination of the similar area is performed. In addition, the distance until a subject is calculated from deviations in position for the first area and the second area. This deviation in positions is referred to as parallax, and it is possible to acquire distance information by using a well-known method such as a triangulation method and the like.

However, in the above-explained method, parallax can only be calculated in integer units for the pixels (referred to below as integer parallax), and more precise calculations of parallax in fraction units cannot be performed for the pixels (referred to below as subpixel parallax). The accuracy of the parallax is directly linked to the accuracy of the 3-dimensional information, and therefore, a method is proposed that more accurately finds the parallax, and for example, a subpixel estimation method is used. This is a method in which the subpixel parallax is calculated by fitting predetermined integers to the lowest correlation value for the degree of difference and a correlation value that is near the lowest correlation value according to the calculation method for the correlation values.

In Nishiguchi, Hitoshi (2008), “a similarity evaluation calculating method for images that have been translated by linear-interpolation and its application to highly accurate sub-pixel matching”, [Master's thesis, Mie University], the shapes of functions that are fitted using autocorrelation values (herein after referred to as fitting functions) in addition to correlation values are estimated, and the subpixel parallax is calculated. An arbitrary area 3 is set in the image 1 as a standard image, an area 4 is set as a reference image in the image 1, and the autocorrelation value is a value that represents the degree of difference (optionally the degree of similarity) between the area 3 and the area 4.

When subpixel estimation is performed, a plurality of correlation values exist that are near the lowest correlation value, and there is a degree of freedom in selecting which of these correlation values that are near the lowest correlation value will be used in the calculation. However, the farther away the position for the reference image from which the correlation value has been calculated is from the true value of the parallax, a larger amount of calculation error is included, and therefore, there is a possibility that if this is used in the subpixel estimation, the calculation error for the parallax that is calculated will also increase.

### SUMMARY

The present disclosure is directed to provide an image processing apparatus that can determine whether or not a reference image that was used in subpixel estimation was appropriate.

According to an aspect of the present disclosure, a degree of reliability calculating apparatus is configured to calculate a degree of reliability for a parallax between a first image and a second image, and includes at least one memory storing instructions; and at least one processor executing the stored instructions causing the degree of reliability calculating apparatus to: set a specific area of the first image as a standard image, and set at least two specific areas of the second image as reference images; acquire a parallax that has been calculated from correlation values indicating an extent of correlation between the standard image and the reference images; estimate a parallax range from positions of the reference images; and calculate a degree of reliability for the parallax that has been acquired based on the parallax range that has been estimated. The at least one processor executing the stored instructions further causes the degree of reliability calculating apparatus to calculate a high degree of reliability in a case in which the parallax is included within the parallax range.

Features of the present disclosure will become apparent from the following description of embodiments with reference to the attached drawings. The following description of embodiments is described by way of example.

### BRIEF DESCRIPTION OF THE DRAWINGS

FIG. 1 is an explanatory diagram for an image capturing apparatus that has been provided with a degree of reliability calculating apparatus according to a First Embodiment.

FIG. 2A, and FIG. 2B are explanatory diagrams for an image capturing element that has been shown in FIG. 1.

FIG. 3 is an explanatory diagram for alight beam that is received by the image capturing element that was shown in FIG. 1.

FIG. 4A and FIG. 4B are explanatory diagrams for the degree of reliability calculating apparatus that was shown in FIG. 1.

FIG. 5A, FIG. 5B, and FIG. 5C are explanatory diagrams for a relationship between a standard image, a reference image, and an auto-reference image.

FIG. 6A, and FIG. 6B are explanatory diagrams for a parallax calculating apparatus that was shown in FIG. 1.

FIG. 7 is an explanatory diagram for an image capturing apparatus according to a Second Embodiment.

FIG. 8 A and FIG. 8B are explanatory diagrams for the degree of reliability calculating apparatus that was shown in FIG. 7.

FIG. 9 is an explanatory diagram for an image capturing apparatus according to a Third Embodiment.

### DESCRIPTION OF THE EMBODIMENTS

Below, embodiments for implementing the present disclosure will be explained using the attached figures. Note that the present disclosure is not limited to the contents that have been disclosed in each embodiment. In addition, each embodiment may also be suitably combined.

### First Embodiment

A detailed explanation of the First Embodiment of the present disclosure will be given while referencing the figures. Note that the configurational elements that are described in the present embodiment are merely an example, and the present disclosure is not limited to the configurational elements that are disclosed in the present embodiment.

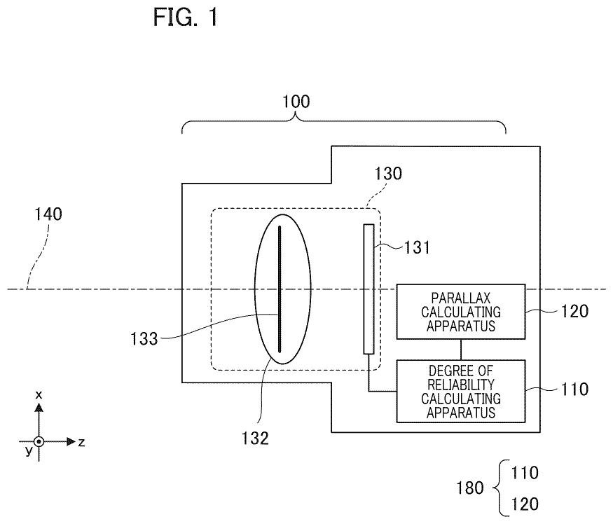

FIG. 1 is a schematic diagram showing a configuration of the image capturing apparatus according to the First Embodiment. In FIG. 1, an image capturing apparatus 100 is provided with a degree of reliability calculating apparatus 110, a parallax calculating apparatus 120, and an image capturing unit 130. In addition, the degree of reliability calculating apparatus 110 and the parallax calculating apparatus 120 configure an image processing apparatus 180 according to the First Embodiment.

The image capturing unit 130 is provided with an image capturing element 131, and an optical system 132. The optical system 132 is an image capturing lens of the image capturing apparatus 100, and has a function of forming images of subjects on the image capturing element 131. The optical system 132 is configured by a plurality of lens groups (not shown), apertures (not shown), and the like, and has an exit pupil 133 in a position that is separated from the image capturing element 131 by a predetermined distance. Note that in the specification of the present disclosure, a direction that is horizontal to an optical axis 140 of the optical system 132 is made a z axis. In addition, a direction that is orthogonal to the z axis (optical axis 140) is made an x axis, and a direction that is orthogonal to the x axis and the z axis is made a y axis.

The image capturing element 131 is configured by a CMOS (complementary metal oxide semiconductor and a CCD (charge-coupled device). The subject images that are formed on the image capturing element 131 via the optical system 132 are photoelectrically converted by the image capturing element 131, and an image signal is generated based on the subject images.

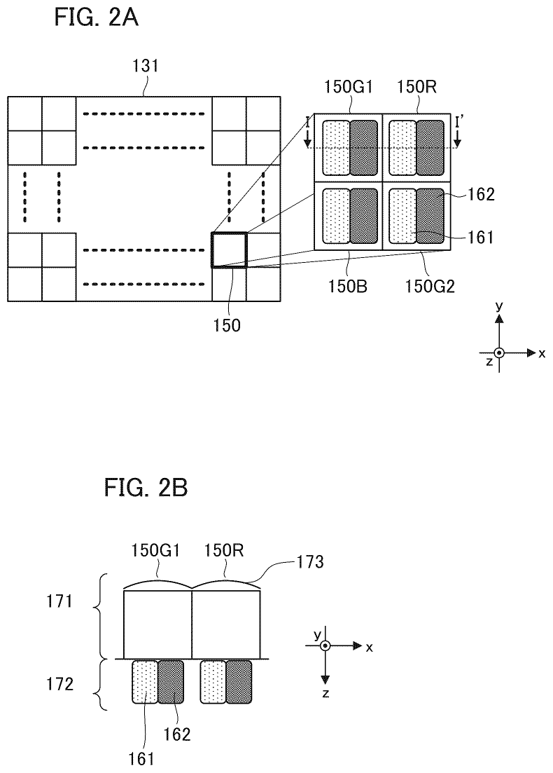

FIG. 2A is an xy cross section diagram of the image capturing element 131. The image capturing element 131 is configured by a plurality of arrays of pixel groups 150 that are 2 rows×2 columns. The pixel group 150 is configured by green pixels 150G1, and 150G2 that are disposed diagonally, and a red pixel 150R and a blue pixel 150B, which are disposed on the remaining two pixels of the pixel group.

FIG. 2B is a schematic diagram that shows an I-I′ cross section of the pixel group 150 from FIG. 2A. Each pixel is configured by a light receiving layer 172, and a light guiding layer 171. Two photelectric conversion units (a first photoelectric conversion unit 161, and a second photoelectric conversion unit 162) for photoelectrically converting the light that has been received are disposed in the light receiving layer 172. That is, the image capturing element 131 is provided with a plurality of first photoelectric conversion units and second photoelectric conversion units. A microlens 173 for accurately guiding the light beams that have become incident on the pixels into the photoelectric conversion units, a color filter (not shown) that allows the passage of light within a predetermined wavelength band, and wiring for use in reading out images and for use in pixel driving (not shown), and the like are disposed in the light guiding layer 171. In addition, wiring that is not shown is provided in each pixel, and it is possible for each pixel to transmit the image signals (output signals) to the degree of reliability calculating apparatus 110 via the wiring.

Although FIG. 2A and FIG. 2B are examples of a photoelectric conversion unit that has been divided into two in one pupil division direction (the direction of the x axis), based on the specifications, an image capturing element may also be used that is provided with a photoelectric conversion apparatus that has been divided in two pupil division directions (the direction of the x axis and the direction of they axis). The pupil division direction and the number into which the photoelectric conversion unit is divided are arbitrary.

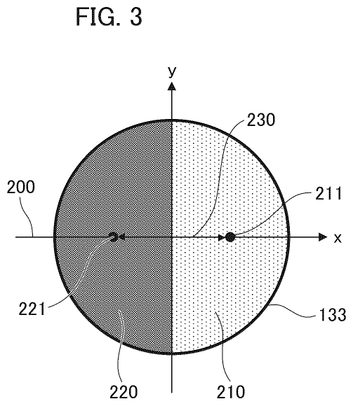

FIG. 3 shows the exit pupil 133 of the optical system 132 as seen from a point of intersection (a center of the image height) of the optical axis 140 and the image capturing element 131. A first beam of light that passes through a first pupil area 210 of the exit pupil 133 becomes incident on the photoelectric conversion unit 161, and a second beam of light that has passed through a second pupil area 220, which is a separate area of the exit pupil 133, becomes incident on the photoelectric conversion unit 162. It is possible to generate an image signal corresponding to an A image (a first image) by photoelectrically converting the beams of light that have become incident on the photoelectric conversion unit 161 of each pixel, and it is possible to generate an image signal corresponding to a B image (a second image) by photoelectrically converting the beams of light that have become incident on the photoelectric conversion unit 162. The image signals that have been generated are transmitted to the degree of reliability calculating apparatus 110.

FIG. 3 shows a center of gravity position (a first center of gravity position 211) for the first pupil area 210, and a center of gravity position (a second center of gravity position 221) for the second pupil area 220, In the present embodiment, the first center of gravity position 211 is decentered (moved) along a first axis 200 from the center of the exit pupil 133. In contrast, the second center of gravity position 221 is decentered (moved) along the first axis 200 in a direction that is opposite to the direction in which the first center of gravity position 211 is decentered. The direction connecting the first center of gravity position 211 and the second center of gravity position 221 is referred to as the pupil divided direction. In addition, the distance between the centers of gravity for the first center of gravity 211 and the second center of gravity 221 becomes abase length 230.

### (Degree of Reliability Calculating Apparatus)

The degree of reliability calculating apparatus 110 of the present embodiment will now be explained. The degree of reliability calculating apparatus 110 can be configured by using logic circuits. In addition, as a different mode, the degree of reliability calculating apparatus 110 may also be configured by a central processing unit (CPU), and a memory storing a computer processing program, and realized by the CPU executing the computer processing program by reading it out from the memory.

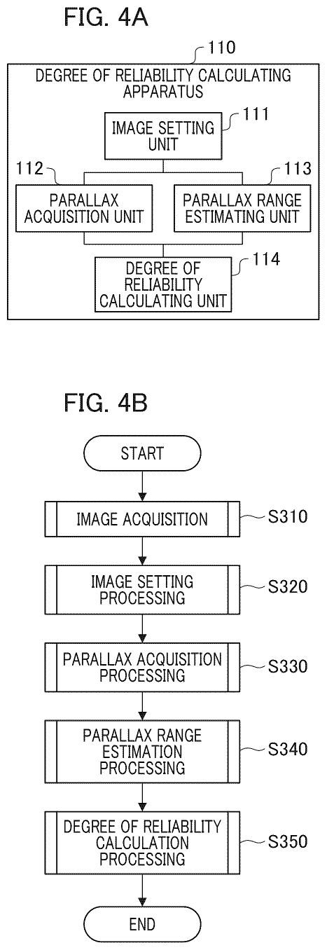

FIG. 4A is a diagram that schematically shows a configuration of the degree of reliability calculating apparatus 110 according to the present embodiment. In FIG. 4A, the degree of reliability calculating apparatus 110 is provided with an image setting unit 111, a parallax acquisition unit 112, a parallax range estimating unit 113, and a degree of reliability calculating unit 114.

The image setting unit 111 sets the standard image and the reference images, which will be explained below. The parallax acquisition unit 112 acquires the parallax, which has been calculated from a correlation value data column for the standard image and the reference image that have been set by the image setting unit 111. The parallax range estimating unit 113 estimates a range of the parallax from a positional relationship between the standard image and the reference images that have been set by the parallax range estimating unit 113. The degree of reliability calculating unit 114 calculates a degree of reliability that indicates a degree of certainty for the parallax that was acquired by the parallax acquisition unit 112.

FIG. 4B is a flowchart showing an operation of the degree of reliability calculating apparatus 110 according to the present embodiment. If the processing according to the present embodiment is begun, the processing transitions to step S310.

During step S310, image capturing is performed using the image capturing apparatus 100, image sets including an A image and a B image that have parallax according to distance are generated and acquired, and the image sets that have been acquired are stored in the memory (not shown) inside of the image capturing apparatus 100.

Step S320 is performed in the image setting unit 111. During step S320, the image setting unit 111 sets an image of a partial area (a specific area) that includes a pixel (target pixel) for which a distance calculation is performed in the A image, which is included in the image set that was acquired during step S310, as the standard image. Furthermore, the image setting unit 111 sets two or more specific areas of the image B that is included in the image set that was acquired during step S310 as the reference image.

Note that at this time the reference image is set at a position that is close to the true value for the parallax, and therefore, the following block matching processing may be performed.

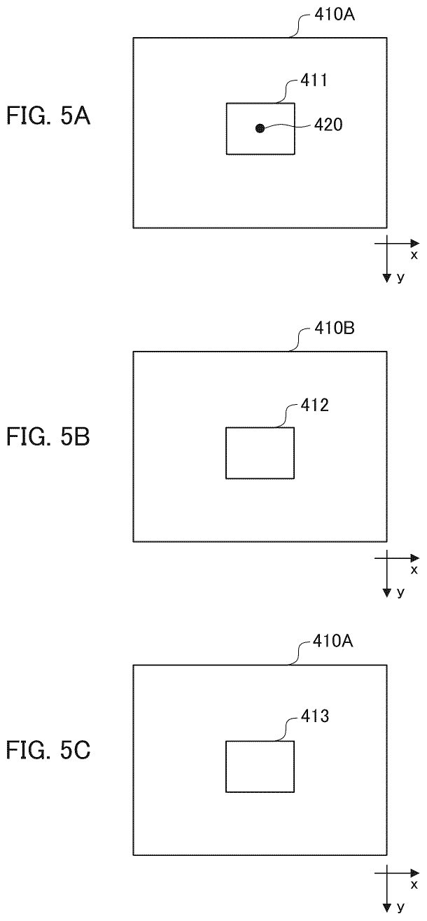

FIG. 5A and FIG. 5B are diagrams for explaining the block matching processing. FIG. 5A shows an A image 410A, and FIG. 5B shows a B image 410B. During the block matching processing, a correlation value is calculated that indicates an extent of the correlation between the A image 410A and the B image 410B.

Specifically, first, the image setting unit 111 extracts a partial area including a pixel of interest 420 and its surrounding pixels in the A image 410 and sets this as the standard image 411. Next, in the B image 410 B, the image setting unit 111 extracts an area with the same area (image size) as the standard image 411 and sets this as a reference image candidate 412. After this, the image setting unit 111 moves the position in which the reference image candidate 412 is extracted in the B image 410B, and calculates a correlation amount for the reference image candidate 412 at each movement amount (each position) and the standard image 411. A correlation value that consists of a correlation value data column corresponding to each movement amount is thereby calculated. In addition, the image setting unit 111 selects the reference image candidate with the position for which the correlation is the highest from among this correlation value data column as a first reference image. Furthermore, the image setting unit 111 selects a reference image candidate that is close to the first reference image as the second reference image. At this time, in a case in which there are a plurality of reference image candidates that are close to the first reference image, the reference image candidate with the highest correlation may also be selected as the second reference image by using the correlation values for each of these reference image candidates.

Note that it is sufficient if the correlation value is able to evaluate the degree of correlation between the standard image 411 and the reference image candidates 412, and this may also be calculated using any well-known method. For example, the square sum difference (SSD), the sum of absolute differences (SAD), and normalized cross correlation can be used. Below, a method will be explained in which SSD is used. Even in a case in which a different method is used, the same approach can be used. SSD evaluates the degree of difference between the standard image 411 and the reference image candidate 412, and the lower that the value for the correlation value becomes, the higher that the degree of correlation becomes.

In addition, the direction in which correlation value calculations are performed by moving the reference image candidate 412 is referred to as the parallax search direction. The parallax search direction may be any direction. However, by setting this to be the same direction as the pupil divided direction, it is possible to easily perform the calculations for the parallax acquisition that will be explained below.

Returning to the explanation of FIG. 4B, step S330 is performed in the parallax acquisition unit. Step S330 acquires the parallax that was calculated by using the correlation value data column for the standard image and the two or more reference images that were set during step S320.

Note that this parallax may be a parallax that has been calculated by using any well-known method. In the present embodiment, a method will be explained in which an autocorrelation value is used. First, from among the correlation value data column, the parallax acquisition unit 112 makes the reference image with reference value for the highest correlation a central reference image, and makes the other reference images surrounding reference images.

Next, the parallax acquisition unit 112 calculates relative positions for the surrounding reference images of the central reference image. For example, in a case in which a specific surrounding reference image is in a position which has been moved more toward the right (the positive direction of the horizontal direction of the image) than the central reference image to an x pixel, and down (the positive direction in the vertical direction of the image) to a y pixel, the position becomes (x, y).

Next, the parallax acquisition unit 112 calculates an autocorrelation value corresponding to the position of the surrounding reference image in relation to the central reference image. Below, an explanation is given of a calculation method for the autocorrelation value. First, in the A image 410 A, as was shown in FIG. 5C, the parallax acquisition unit 112 extracts an area having the same area (image size) as the standard image 411 and sets this as an auto reference image 413. At this time, the position of the auto reference image 413 in relation to the standard image 411 is set so as to correspond to the position of the surrounding reference image in relation to the central reference image. Next, the parallax acquisition 112 calculates an autocorrelation value indicating the degree of correlation for the auto reference image 413 in this position and the standard image 411.

Note that it is sufficient if the autocorrelation value is able to evaluate the degree of correlation between the standard image 411 and the auto reference image 413, and may be calculated using any well-known method. For example, the square sum difference (SSD), the sum of absolute differences (SAD), and normalized cross correlation can be used. By calculating the autocorrelation using the same method as the correlation value, it is possible to more precisely perform the parallax calculation to be described below.

Finally, the parallax acquisition unit 112 calculates the parallax from the differences between each correlation value and the ratio of the autocorrelation values. For example, the correlation value for between the reference image for which the relative position from the central reference image is (x, y), and the standard image is made S(x,y). In addition, the autocorrelation value for between the auto reference image, for which the relative position from the standard image is (x, y), and the standard image is made C(x, y). It is thereby possible to calculate a parallax disp for the horizontal direction by using the formula (1).

$$\begin{matrix}[ Formula 1 ] & \\ disp = \frac{S ( 0 , 0 ) - S ( 1 , 0 )}{2 C ( 1 , 0 )} + 0.5 & ( 1 )\end{matrix}$$

Returning to the explanation of FIG. 4B, step S340 is performed in the parallax range estimating unit 113. During step S340, the parallax range estimating unit 113 estimates a range of the parallax (a parallax range) from the positional relationships between the standard image and the two or more reference images that were set during step S320. For example, the displacement of the positions for the standard image and each reference image (positional displacement) may be calculated, and the parallax range may be estimated to be the range from the minimum value of this positional displacement until the maximum value of this positional displacement.

The parallax range may also be made a range that has been enlarged from the range from the minimum value of the positional displacement to the maximum value of the positional displacement by a predetermined value (expanded by a predetermined amount). In this case, the resistance toward noise increases, and therefore, it is possible to perform the degree of reliability calculation to be described below with a higher degree of precision.

Step S350 is performed in the degree of reliability calculating unit 114. During step S350, the degree of reliability calculating unit 114 calculates the degree of reliability, which indicates the degree of certainty of the parallax that was acquired during step S330. During step S350, in a case in which the parallax that was acquired during step S330 is included in the parallax range that was estimated during step S340, a high degree of reliability is calculated, and in other cases a low degree of reliability is calculated. As long as it fulfills the above-described conditions, the method for calculating the degree of reliability is arbitrary, and for example, a method can also be used in which in a case in which the parallax that was acquired during step S330 is within the parallax range that was estimated during step S340, the degree of reliability is made “1”, and in all other cases, the degree of reliability is made “0”.

Above, according to the explanation of FIG. 4B, step S320 functions as an image setting process, step S330 functions as a parallax acquisition process, step S340 functions as a parallax range estimating process, and step S350 functions as a degree of reliability calculating process.

(parallax calculating apparatus)

The parallax calculating apparatus 120 of the present embodiment will now be explained. The parallax calculating apparatus 120 can be configured by logic circuits. In addition, as a different mode, the parallax calculating apparatus 120 may also be configured by a CPU, and a memory storing a computer processing program, and realized by the CPU executing the computer processing program by reading it out from the memory.

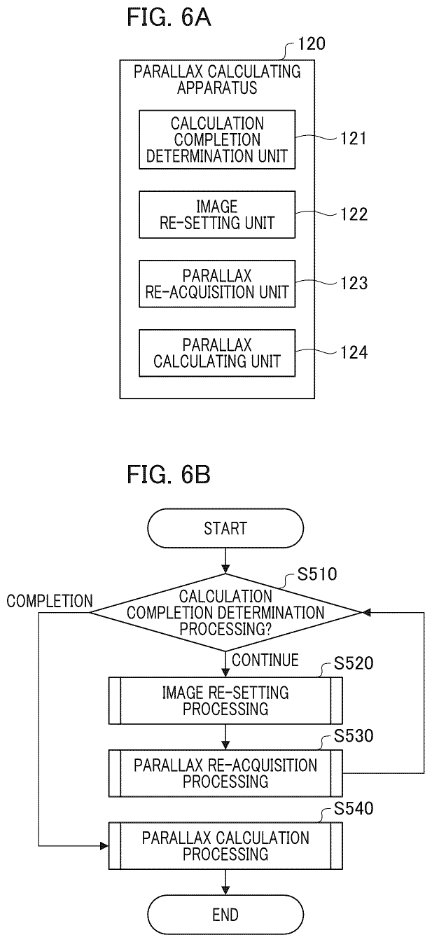

FIG. 6A is a diagram schematically showing a configuration of a parallax calculating apparatus 120 according to the present embodiment. In FIG. 6A the parallax calculating apparatus 120 is provided with a calculation completion determining unit 121, an image re-setting unit 122, a parallax re-acquisition unit 123, and the parallax calculating unit 124.

The calculation completion determining unit 121 acquires the degree of reliability that was calculated by the degree of reliability calculating apparatus 110, and determines that further calculations will be completed according to the degree of reliability. The image re-setting unit 122 changes the position of the reference image that has been used in the parallax calculation for which the degree of reliability has been determined to be low in the calculation completion determining unit 121. The parallax re-acquisition unit 123 acquires the parallax that has been calculated from the correlation data column for between the standard image and the reference image that has been re-set by the image re-setting unit 122. The parallax calculating unit 124 acquires the parallax for which the degree of reliability has been determined to be high by the calculation completion determining unit 121, and calculates the value thereof.

FIG. 6B is a flowchart showing operations of the parallax calculating apparatus 120 of the present embodiment. If the processing according to the present embodiment is begun, the processing transitions to step S510.

Step S510 is performed in the calculation completion determining unit 121. During step S510, the degree of reliability that was calculated in the degree of reliability calculating apparatus 110 is acquired. In a case in which this degree of reliability is high, the calculation completion determining unit 121 completes the calculations, and in a case in which this degree of reliability is low, the calculation completion determining unit 121 continues the calculations. Conversely, a determination may also be performed in which calculation is completed when predetermined conditions are fulfilled. For example, the number of times that calculations have been performed may also be stored, and a determination may be performed such that in a case in which the number of times that calculations were performed is equal to or greater than a predetermined number of times, the calculations are completed. In addition, a determination may also be performed such that the calculations are completed in a case in which there are no reference images to be re-set during a step S520, which will be described below.

Step S520 is performed in the image re-setting unit 122. During step S520, the image re-setting unit 122 changes the position of the reference image that has been used in parallax calculation for which it has been determined that the degree of reliability is low during step S510. That is, in a case in which a high degree of reliability could not be obtained, the image re-setting unit 122 sets new reference images by changing the position of one or more reference images.

In this case, the position of the reference image is changed to a position in which the parallax is close to the parallax true value, and therefore, the image re-setting unit 122 may also calculate the position for after the change from the parallax. For example, the displacement of the positions between the standard image and each of the reference images after displacement may be calculated, and the positions may be changed such that the parallax enters the range from the minimum value to the maximum value thereof.

Step S530 is performed in the parallax re-acquisition unit 123. During step S530, the parallax re-acquisition unit 123 acquires the parallax (corrected parallax) that has been calculated by using the correlation value data column for the standard image and the reference images that were re-set during step S520. Note that this parallax may also be calculated using any well-known method. That is, the parallax re-acquisition unit 123 acquires the corrected parallax that has been calculated from a correlation value indicating the extent of the correlation between the standard image and the reference images.

Step S540 is performed in the parallax calculating unit 124. During step S540, the parallax calculating unit 124 acquires the parallax for which the degree of reliability has been determined to be high during step S510, and calculates this value.

In addition, during step S540, in a case in which although the degree of reliability was low, the calculations were completed due to predetermined conditions having been fulfilled, it may also be made such that an error value is output. In addition, the average value, and the median value for the parallaxes that have been acquired up until this point may also be output. In addition, the parallax having the highest degree of reliability may also be output.

### (Variation)

In this context, a variation of the present embodiment will be explained. During step S330 of FIG. 4B, parallaxes may also be acquired along a plurality of directions. For example, the parallax acquisition unit 112 may also acquire two parallaxes, the parallax for the horizontal direction of the image, and the parallax for the vertical direction of the image. Note that these parallaxes may also have been calculated using any well-known method.

One example of a method for two-dimensionally expanding the method using the above-described autocorrelation value will be explained. It is also possible to execute this method in the parallax acquisition unit 120. First, a horizontal extremal line is estimated, which is a straight line at which a value in which partial differentiation has been performed in the horizontal direction on the correlation value in a 2-dimensional continuous area becomes 0. In this context, the parallax in the horizontal direction for the time at which the relative position in the vertical direction from the central reference image has been made v is made dispH(v)(refer to the formula 1 for the parallax disp). It is possible to calculate the horizontal extremal line from two or more dispH(v) in which v has been changed. For example, it is possible to find this using the Formula (2).

$$\begin{matrix}[ Formula 2 ] & \\ \begin{matrix}x = ay + b \\ a = dispH ( 1 ) - dispH ( 0 ) \\ b = dispH ( 0 )\end{matrix} \} & ( 2 )\end{matrix}$$

Next, a vertical extremal line is estimated, which is a straight line in which a value in which partial differentiation has been performed in the vertical direction on the correlation value in a two-dimensional continues space becomes 0. In this context, the parallax in the vertical direction from the time when the relative position in the horizontal direction from the central reference image was made h is made dispV(h). The vertical extremal line can be calculated from two or more dispV(h) values in which h has been changed. For example, this can be found using the Formula (3).

$$\begin{matrix}[ Formula 3 ] & \\ \begin{matrix}y = Ax + B \\ A = dispV ( 1 ) - dispV ( 0 ) \\ B = dispV ( 0 )\end{matrix} \} & ( 3 )\end{matrix}$$

In addition, the point of intersection for the horizontal extremal line and the vertical extremal line (dispX, dispY) is calculated using the Formula 4, and this position is output as the parallax.

$$\begin{matrix}[ Formula 4 ] & \\ \begin{matrix}dispX = \frac{aB + b}{1 - aA} \\ dispY = \frac{Ab + B}{1 - aA}\end{matrix} \} & ( 4 )\end{matrix}$$

In the following step S340, the parallax range determining unit 113 may also estimate ranges of parallaxes (parallax range) in a plurality of directions. For example ranges for the two parallaxes of the parallax for the horizontal direction of the image, and the parallax for the vertical direction of the image may also be estimated.

For example, the parallax range estimating unit 113 may also calculate a positional displacement for each reference image that was used when calculating the horizontal extremal line and the standard image, and the range from the minimum value to the maximum value for the vertical direction thereof may also be estimated as the horizontal direction parallax range. In addition, a range that has been expanded by the amount of the measurement error for the parallax in the vertical direction that is estimated from the minimum value until the maximum value in the vertical direction may also be estimated as the parallax range in the vertical direction.

In addition, the parallax range estimating unit 113 may also calculate a positional displacement for each reference image that was used when calculating the vertical extremal line and the standard image, and the range from the minimum value to the maximum value for the horizontal direction thereof may also be estimated as the horizontal direction parallax range. In addition, a range that has been expanded from range of the minimum value until the maximum value in the horizontal direction by the amount of the measurement error for the parallax in the horizontal direction that was estimated may also be estimated as the range for the parallax in the horizontal direction.

In addition, during step S350, the degree of reliability calculating unit 114 may also perform determinations for parallaxes in a plurality of directions, and may also calculate one degree of reliability. For example, the degree of reliability calculating unit 114 may also make the degree of reliability high in a case in which there is a parallax dispX in the horizontal direction that is within the parallax range for the horizontal direction, as well as a parallax disp Y in the vertical direction that is within the parallax range in the vertical direction, and make the degree of reliability low in all other cases. In addition, the degree of reliability calculating unit 114 may also individually perform determinations with respect to the parallaxes for each of the directions, and may also calculate a plurality of degrees of reliability. That is, the degree of reliability calculating unit 114 may also calculate the degree of reliability from the parallaxes and parallax ranges with respect to a plurality of directions. Furthermore, the degree of reliability calculating unit 114 may also calculate a high degree of reliability in a case in which the parallaxes are included in all of the parallax ranges for a plurality of directions.

According to the degree of reliability calculating apparatus for the present embodiment, it is possible to calculate a degree of reliability relating to parallaxes for a plurality of directions.

According to the degree of reliability calculating apparatus 110 of the present embodiment that has been described above, a degree of reliability for a parallax is calculated by using the positional relationship between the standard image and two or more reference images. According to this processing, it is possible to estimate calculation errors that are included in parallaxes by estimating the effect of calculation errors that are included in the correlation values that are used during the parallax calculations.

### Second Embodiment

Next, a Second Embodiment of the present disclosure will be explained in detail with reference to the attached figures. Portions of the Second Embodiment for which the configurations and operations are the same as the configurations and operations that were explained in the First Embodiment will be assigned the same reference numerals, and explanations thereof will be omitted. Note that the configurational elements that are disclosed in the present embodiment are simply examples, and the present disclosure is not limited by the configurational elements that are disclosed in the present embodiment.

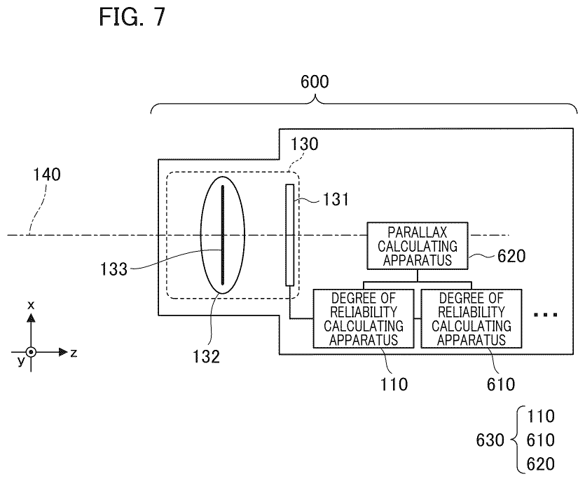

The image capturing apparatus 600 of the present embodiment will be explained. FIG. 7 is a diagram schematically showing a configuration of the image capturing apparatus 600 according to the present embodiment. In FIG. 7, the image capturing apparatus 600 is provided with the degree of reliability calculating apparatus 110, one or more degree of reliability calculating apparatuses 610, a parallax calculating apparatus 620, and the image capturing unit 130.

In the image capturing apparatus 600 according to the present embodiment, the degree of reliability calculating apparatus 610 has been added to the image capturing apparatus 100 that was shown in the First Embodiment, and the parallax calculating apparatus 120 has been changed to the parallax calculating apparatus 620. In addition, the degree of reliability calculating apparatus 110, the degree of reliability calculating apparatus 610, and the parallax calculating apparatus 620 configure an image processing apparatus 630 according to the present embodiment. That is, the image capturing apparatus 600 is provided with a plurality of degree of reliability calculating apparatuses.

The degree of reliability calculating apparatus 610, and the parallax calculating apparatus 620 can be configured using logical circuits. In addition, as a different mode, the degree of reliability calculating apparatus 610, and the parallax calculating apparatus 620 may also be configured by a CPU, and a memory storing a computer processing program, and may be realized by the CPU executing the computer processing program by reading it out from the memory.

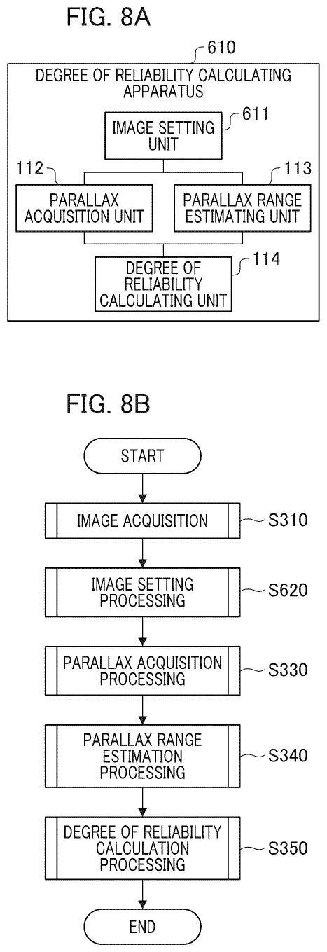

FIG. 8A is a diagram schematically showing a configuration of a degree of reliability calculating apparatus 610 according to the present embodiment. In FIG. 8A, the degree of reliability calculating apparatus 610 is provided with an image setting unit 611, the parallax acquisition unit 112, the parallax range estimating unit 113, and the degree of reliability calculating unit 114.

In the degree of reliability calculating apparatus 610, in relation to the degree of reliability calculating apparatus 110 that was shown in the First Embodiment, the image setting unit 111 has been changed to the image setting unit 611. The image setting unit 611 sets the standard image and the reference images. However, as will be explained below, the image setting unit 611 sets different reference images than those that were set in the degree of reliability calculating apparatus 110.

FIG. 8B is a flowchart showing operations of the degree of reliability calculating apparatus 610 of the present embodiment. In FIG. 8B, in relation to the flowchart that was shown in FIG. 4B, step S320 has been changed to step S620.

Step S620 is performed in the image setting unit 611. During step S620, the image setting unit 611 sets an image of a partial area that includes a pixel for which distance calculation will be performed (a target pixel) in the A image of the image set that was acquired during step S310, as the standard image. Furthermore, the image setting unit 611 sets two or more reference images in the B image. At this time, at least one reference image is set that is different than the reference images that were set in the degree of reliability calculating apparatus 110.

Note that in a case in which two or more degree of reliability calculating apparatuses 610 are provided, at least one of the reference images that is set in one degree of reliability calculating apparatus is set to a reference image that is different than the reference images that have been set by the degree of reliability calculating apparatus 110 and the other degree of reliability detecting apparatus 610.

The parallax calculating apparatus 620 acquires two or more degrees of reliability, and determines the parallax based on the degrees of reliability. First, the parallax calculating apparatus 620 acquires the degrees of reliability from the degree of reliability calculating apparatus 110 and the one or more degree of reliability calculating apparatuses 610. Next, the parallax calculating apparatus 620 compares each degree of reliability that has been acquired, and determines (calculates) the parallax. For example, the parallax having the highest degree of reliability from among each of the degrees of reliability may be output. In addition, in a case in which all of the degrees of reliability are low, an error value may also be output.

According to the present embodiment, it is possible to comprehensively evaluate the parallax and the degree of reliability thereof by using a plurality of degrees of reliability, and it is therefore possible to correctly calculate the parallax.

### Third Embodiment

Next, a detailed explanation will be given of a Third Embodiment of the present disclosure while referencing the attached figures. Portions for which the configurations and operations are the same as the configurations and operations that were explained in First Embodiment and the Second Embodiment will be assigned the same reference numerals, and explanations thereof will be omitted. Note that the configurational elements that are disclosed in the present embodiment are simply an example, and the present disclosure is not limited by the configurational elements that are disclosed in the present embodiment.

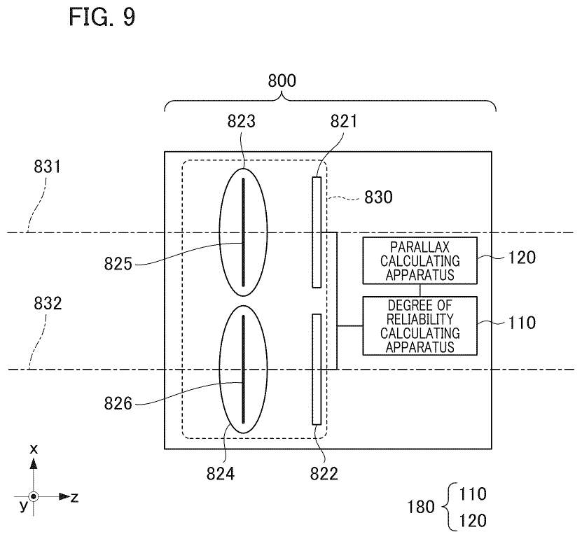

An image capturing apparatus 800 of the present embodiment will now be explained. FIG. 9 is a diagram that schematically shows a configuration of the image capturing apparatus 800 according to the present embodiment. In FIG. 9, the image capturing apparatus 800 is provided with the degree of reliability calculating apparatus 110, the parallax calculating apparatus 120, and an image capturing unit 830.

In the image capturing apparatus 800 according to the present embodiment, in relation to the image capturing apparatus 100 that was shown in the First Embodiment, the image capturing unit 130 has been changed to the image capturing unit 830.

The image capturing unit 830 is provided with two image capturing elements, an image capturing element 821, an image capturing element 822, and two optical systems, an optical system 823, and an optical system 824. The optical system 823 is an image capturing lens in the image capturing apparatus 800, and has the function of forming images of subjects on the image capturing element 821, while the optical system 824 is also an image capturing lens in the image capturing apparatus 800, and has the function of forming images of subjects on the image capturing element 822. The optical system 823 and the optical system 824 are both configured by a plurality of lens groups (not shown), apertures (not shown), and the like. The optical system 823 has an exit pupil 825 in a position that has been separated from the image capturing element 821 by a predetermined distance, and the optical system 824 has an exit pupil 826 in a position that has been separated from the image capturing element 822 by a predetermined distance. At this time, the optical axis of the optical system 823 is 831, and the optical axis of the optical system 824 is 832.

That is, the image capturing element 821 functions as a first image capturing element, the optical system 823 functions as a first optical system, the image capturing element 822 functions as a second image capturing element, and the optical system 824 functions as a second optical system. Therefore, a first image (A image) is acquired by the image capturing element 821, and a second image (B image) is acquired by the image capturing element 822.

In the present embodiment, it is possible to correctly calculate the parallax between images by correcting parameters in advance such as the positional relationship between the optical systems, and the like. In addition, it is also possible to correctly calculate the parallax between images by performing corrections for lens distortions in both of the optical systems. In this case, the degree of design freedom for the baseline length increases, and it is possible to improve the measurement resolution.

In the present embodiment, although there are two optical systems that acquire the A photo and the B photo, between which there is parallax according to distance, the present embodiment may also be configured by a stereo camera configured by three or more optical systems and image capturing elements corresponding to these optical systems.

In the present embodiment, although the configurations that were explained in the First Embodiment are applied to the degree of reliability calculating apparatus and the parallax calculating apparatus, the configurations that were explained in the Second Embodiment may also be applied to the degree of reliability calculating apparatus and the parallax calculating apparatus.

According to the present embodiment it is possible to determine whether or not a reference image that was used in sub pixel estimation was appropriate by calculating a degree of reliability that indicates a degree of certainty of the parallax.

The present disclosure also includes a computer program in addition to the measuring apparatus. The computer program of the present embodiment executes a predetermined process in a computer in order to calculate a distance or a parallax amount. The program of the present embodiment is installed in a distance measurement apparatus or on a computer of an image capturing apparatus such as a digital camera and the like that is provided with the measuring apparatus. The above-described functions are realized by the computer program that has been installed being executed by the computer, and rapid, high precision parallax calculations become possible.

In addition, the present disclosure can also be realized by processing in which a program that realizes one or more functions of the above described embodiments is provided to a system or apparatus via a network or storage medium, and one or more processors in a computer of this system or apparatus reads out and executes the program. In addition, the present disclosure may also be realized by a circuit (for example, an ASIC) that realizes one or more functions.

### OTHER EMBODIMENTS

Although above, embodiments of the present application have been explained, the present disclosure is not limited to these embodiments, and various changes and alterations are possible within the scope of the gist thereof. In addition, the above-described embodiments may also be implemented by being combined.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-008170, filed Jan. 21, 2025, which is hereby incorporated by reference herein in its entirety.

What is claimed is:

1. A degree of reliability calculating apparatus configured to calculate a degree of reliability for a parallax between a first image and a second image, the degree of reliability calculating apparatus comprising:
at least one memory storing instructions; and
at least one processor executing the stored instructions causing the degree of reliability calculating apparatus to:
set a specific area of the first image as a standard image, and set at least two specific areas of the second image as reference images;
acquire a parallax that has been calculated from correlation values indicating an extent of correlation between the standard image and the reference images;
estimate a parallax range from positions of the reference images; and
calculate a degree of reliability for the parallax that has been acquired based on the parallax range that has been estimated,
wherein the at least one processor executing the stored instructions further causes the degree of reliability calculating apparatus to calculate a high degree of reliability in a case in which the parallax is included within the parallax range.

2. The degree of reliability calculating apparatus according to claim 1,
wherein the as least one processor executing the stored instructions further causes the degree of reliability calculating apparatus to:
calculate a positional displacement between the standard image and each of the reference images; and
estimate, as the parallax range, a range from a minimum value of the positional displacement to a maximum value of the positional displacement.

3. The degree of reliability calculating apparatus according to claim 1,
wherein the at least one processor executing the stored instructions further causes the degree of reliability calculating apparatus to:
calculate a positional displacement between the standard image and each of the reference images; and
estimate, as the parallax range, a range that has been expanded by a particular amount from a range from a minimum value of the positional displacement to a maximum value of the positional displacement.

4. The degree of reliability calculating apparatus according to claim 1,
wherein the at least one processor executing the stored instructions further causes the degree of reliability calculating apparatus to:
acquire parallaxes along a plurality of directions;
estimate parallax ranges for the plurality of directions; and
calculate a degree of reliability from the parallaxes and the parallax ranges for the plurality of directions.

5. The degree of reliability calculating apparatus according to claim 4,
wherein the at least one processor executing the stored instructions further causes the degree of reliability calculating apparatus to calculate a high degree of reliability in a case in which the parallaxes are included within all of the parallax ranges for the plurality of directions.

6. An image processing apparatus comprising:
a degree of reliability calculating apparatus including:
at least one first memory storing first instructions; and
at least one first processor executing the stored first instructions causing the degree of reliability calculating apparatus to:
set a specific area of a first image as a standard image, and set at least two specific areas of a second image as reference images;
acquire a parallax between the first image and the second image that has been calculated from correlation values indicating an extent of correlation between the standard image and the reference images;
estimate a parallax range from positions of the reference images; and
calculate a degree of reliability for the parallax that has been acquired based on the parallax range that has been estimated,
wherein the at least one first processor executing the stored first instructions further causes the degree of reliability calculating apparatus to calculate a high degree of reliability in a case in which the parallax is included within the parallax range;
at least one second memory storing second instructions; and
at least one second processor executing the stored second instructions, causing the image processing apparatus to:
set a new reference image by changing the position of at least one of the reference images in a case in which the high degree of reliability could not be obtained; and
acquire a corrected parallax that has been calculated from a correlation value indicating an extent of correlation between the standard image and the new reference images.

7. The image processing apparatus according to claim 6,
wherein the at least one second processor executing the stored second instructions further causes the image processing apparatus to set the new reference image such that the parallax is within a range from a minimum value of a positional displacement between the standard image and the new reference images to a maximum value of the positional displacement of the standard image and the new reference images.

8. An image processing apparatus comprising:
a plurality of degree of reliability calculating apparatuses, each of the degree of reliability calculating apparatuses including:
at least one first memory storing first instructions; and
at least one first processor executing the stored first instructions causing the degree of reliability calculating apparatus to:
set a specific area of a first image as a standard image, and set at least two specific areas of a second image as reference images;
acquire a parallax between the first image and the second image that has been calculated from correlation values indicating an extent of correlation between the standard image and the reference images;
estimate a parallax range from positions of the reference images; and
calculate a degree of reliability for the parallax that has been acquired based on the parallax range that has been estimated,
wherein the at least one first processor executing the stored first instructions further causes the degree of reliability calculating apparatus to calculate a high degree of reliability in a case in which the parallax is included within the parallax range;
at least one second memory storing second instructions; and
at least one second processor executing the stored second instructions causing the image processing apparatus to:
calculate a parallax by comparing a plurality of degrees of reliability that have been calculated by the degree of reliability calculating apparatuses.

9. An image capturing apparatus comprising:
an image capturing unit; and
a degree of reliability calculating apparatus including:
at least one memory storing instructions; and
at least one processor executing the stored instructions causing the degree of reliability calculating apparatus to:
set a specific area of a first image as a standard image, and set at least two specific areas of a second image as reference images;
acquire a parallax that has been calculated from correlation values indicating an extent of correlation between the standard image and the reference images;
estimate a parallax range from positions of the reference images; and
calculate a degree of reliability for the parallax that has been acquired based on the parallax range that has been estimated,
wherein the at least one processor executing the stored instructions further causes the degree of reliability calculating apparatus to calculate a high degree of reliability in a case in which the parallax is included within the parallax range.

10. The image capturing apparatus according to claim 9,
wherein the image capturing unit is provided with an optical system, and an image capturing element,
the optical system forms an image of a subject on the image capturing element, and
the image capturing element is provided with a plurality of first photoelectric conversion units for generating the first image, and a plurality of second photoelectric conversion elements for generating the second image.

11. The image capturing apparatus according to claim 9,
wherein the image capturing unit is provided with:
a first image capturing element;
a first optical system configured to form an image of the subject on the first image capturing element;
a second image capturing element; and
a second optical system configured to form an image of the subject on the second image capturing element,
wherein the first image is acquired by the first image capturing element, and the second image is acquired by the second image capturing element.

12. A degree of reliability calculating method for calculating a degree of reliability for a parallax between a first image and a second image, the degree of reliability calculating method comprising:
setting a specific area of the first image as a standard image, and setting at least two specific areas of the second image as reference images;
acquiring a parallax that has been calculated from correlation values indicating an extent of correlation between the standard image and the reference images;
estimating a parallax range from positions of the reference images; and
calculating a degree of reliability for the parallax that has been acquired based on the parallax range that has been estimated,
wherein a high degree of reliability is calculated in a case in which the parallax is included within the parallax range.

13. A non-transitory storage medium storing a program of a degree of reliability calculating apparatus, causing a computer program to perform each step of a degree of reliability calculating method for calculating a degree of reliability for a parallax between a first image and a second image, the degree of reliability calculating method comprising:
setting a specific area of the first image as a standard image, and setting at least two specific areas of the second image as reference images;
acquiring a parallax that has been calculated from correlation values indicating an extent of correlation between the standard image and the reference images;
estimating a parallax range from positions of the reference images; and
calculating a degree of reliability for the parallax that has been obtained based on the parallax range that has been estimated,
wherein a high degree of reliability is calculated in a case in which the parallax is included within the parallax range.
